(19) United States
(12) Patent Application Publication
(10) Pub. No.: US 2009/0317710 A1
(43) Pub. Date: Dec. 24, 2009

(54) ANODE, CATHODE, GRID AND CURRENT COLLECTOR MATERIAL FOR REDUCED WEIGHT BATTERY AND PROCESS FOR PRODUCTION THEREOF

(75) Inventors: Joel S. Douglas, Groton, CT (US); Thomas Barbarich, Westerly, RI (US)

Correspondence Address: MICHAUD-DUFFY GROUP LLP, 306 INDUSTRIAL PARK ROAD, SUITE 206, MIDDLETOWN, CT, 06457, US

(73) Assignee: MysticMD, Inc., Groton, CT (US)

(21) Appl. No.: 12/485,099

(22) Filed: Jun. 16, 2009

Related U.S. Application Data
(60) Provisional application No. 61/132,688, filed on Jun. 20, 2008.

(51) Int. Cl. H01M 4/02; H01M 2/02

(52) U.S. Cl. 429/163; 429/231.8; 429/221; 429/225; 429/228; 977/773

(57) ABSTRACT

A process for producing lightweight materials for a battery comprises lightweight polymer substrate coated with dispersions of nano particles, conductive matrixes and active material.

### CROSS REFERENCE TO RELATED APPLICATIONS

This application claims the benefits of U.S. Provisional Application No. 61/132,688, filed on Jun. 20, 2008, entitled “Anode, cathode, grid and current collector material for reduced weight battery, process for production thereof,” the contents of which are incorporated herein by reference in its entirety.

### FIELD OF THE INVENTION

The present invention relates to lightweight battery material enabling production of lightweight batteries having large capacity, high voltage, and desirable charge-discharge cycle properties, such material being free from decomposition by the electrolytic solution of the battery; a process for production of anode and cathode materials; a process for production of a current collector material; and a process for production of a grid material for use in lead acid, lithium ion, and silver zinc batteries. The anodes and cathodes are made from electrically conductive coatings formed from dispersions and deposited on non-conductive substrates to make lightweight flexible battery cells. More particularly, the invention relates to electrically conductive coatings comprised of carbon nanotubes (CNT), dispersions of carbon nanotubes, carbon, graphite fibers, and conductive oxides, and composite coatings formed from dispersions of carbon nanotubes, active materials, carbon, conductive metal oxide, and polymer binders. The lightweight material is formed by depositing a dispersion, suspension, or mixture of conductive material onto a non-conductive substrate, thereby creating a coating that adheres to the substrate and is also ductile. The invention uses non woven or woven material as the substrate for the current collector, or it uses organic fibers as the current collector.

### BACKGROUND OF THE INVENTION

Advancements in electronics technology have led to the production of handheld electronic equipment and other battery operated devices. These advancements have revolutionized the electronic equipment industry at both the consumer and industrial levels. Batteries are widely used in a variety of such devices, such as computers, power tools, personal communication systems such as telephones, personal entertainment systems, and security systems. Development of these types of devices has brought about the evolution of batteries as miniature power supplies. In order to supply sufficient power, batteries have been called upon to produce higher energy per unit volume outputs and to exhibit superior discharge characteristics.

Batteries are typically fabricated using an alkali metal anode or carbon which has the alkali metal incorporated therein during formation, a non-aqueous electrolyte, and a cathode, such as recited in the teachings of U.S. Pat. Nos. 4,621,035; 4,888,206; 4,911,995; 5,169,446; and 5,080,932. Of the alkali metals commercially feasible in manufacturing the anode, lithium is preferred because it has a low atomic weight while having a high electronegativity. Thus, batteries having lithium anodes generally exhibit a high energy density, a long shelf life, and fairly efficient operation over a wide range of temperatures.

One known method for fabricating a battery cell (a battery is a collection of cells) is to use metal foils to form current collectors for both the anode and cathode. The purpose of the current collectors is to provide a medium for transporting electrons to the terminals of the battery or cell. In production, the current collector can comprise a variety of conductive materials, including but not limited to stainless steel, copper, nickel, titanium, or aluminum. However, the use of copper and aluminum adds cost and results in additional battery weight.

In the manufacturing process, a cathode layer is formed and positioned so that it is in communication with a cathode current collector, preferably by extrusion or coating. The anode is formed and positioned so that it is also in communication with an anode current collector, preferably by extrusion or coating. Separator and electrolyte layers are positioned between the anode and cathode forming a current collector-cathode-electrolyte-anode-current collector “sandwich.” The separator is used to prevent direct contact between an anode section and a cathode section. The separator can be a film or a fabric, depending on the battery type. In addition to maintaining physical separation of the anode section and the cathode section, a separator is designed to perform several other functions, such as forming an ionic pathway, between the anode section and cathode section, providing electronic insulation, providing mechanical support, and functioning as a layer binding the anode section and cathode section. Normally the battery or cell is then packaged in a metal enclosure, such that the anode current collector is in electrical communication with a terminal at the anode end of the enclosure and further such that the cathode current collector is in electrical communication with a cathode terminal at the cathode end of the enclosure. One issue with this construction is that the metal foil when used in a prismatic cell design is very rigid.

Previously, battery/cell manufacturing technology has relied on forming and assembling the current collectors, anode, electrolyte, and cathode of the battery as separate components. However, this is a relatively labor intensive procedure that involves assembly of a number of discrete components, adding weight and cost to the manufacture the battery or cell. The current collector materials commonly used are lead, copper, aluminum, silver and zinc, all of which add cost to the battery.

In response to these issues, there have been several developments in battery manufacturing processes. These advancements, described in U.S. Pat. No. 4,911,995 and U.S. Pat. No. 4,621,035, have relied on the use of a thin metal film as a metalization layer. This metalization layer is then employed with an alkali metal to form an anode. However, these approaches fail to provide a battery with the flexibility and durability required in some applications, as well as a simple means for manufacturing.

U.S. Pat. No. 6,025,089, U.S. Pat. No. 5,906,661, U.S. Pat. No. 6,045,942, U.S. Pat. No. 5,865,859, U.S. Pat. No. 5,735,912, and U.S. Pat. No. 5,747,191 describe the manufacture of thin film batteries involving fusing an alkali metal onto a patterned conductive layer. Alternatively, thin film batteries can be manufactured using a method that includes providing a cathode base as a first nonconductive surface, adding a conductive layer to the first nonconductive surface formed from ink, then placing a cathode layer adjacent the conductive layer.

Processes that use polymer thick film inks have not been capable of providing a conductive layer from which to form an anode or cathode capable of supporting high-energy applications. Many of the difficulties implementing polymer batteries are related to temperatures found in the battery during discharge and recharging activities. The anodes and cathodes formed from polymers and inks cannot withstand the heat generated from recharging, rapid discharge, a long sustained discharge, or multiple episodic discharges in a short period. These issues are compounded in part because the polymer inks and films do not efficiently handle both heat and current.

Also, as electronic appliances have become smaller and lighter, the batteries used to power them have a higher energy density. This means that there exists a desire to develop a lightweight high-performance secondary (e.g., rechargeable) battery, thereby allowing repeated charge and discharge from the standpoint of resource saving. In order to respond to these requirements, replacement battery material for current collectors, anodes, cathodes, laminar electrodes, and grids are employed.

In a move to reduce weight and increase voltage and amp-hour ratings, the industry has moved to lithium batteries. This change has not fully met the need for lighter weight and more flexible batteries that was expected by customers. As the battery manufacturing and electronics community moves to lithium-ion secondary batteries, the performance of these batteries is still inadequate for various applications. Even though lithium-ion provides high energy density, has high specific energy, excellent cycling life and calendar life, lithium-ion batteries may still be undesirable in many applications, for example, in applications in which weight is an issue. Thus, a shift to a lithium-ion alone is generally not suitable for all current and anticipated commercial and military users.

Using a lithium-ion secondary battery as an example, the energy density can be 250-550 watt hour/liter or more. This capacity is large as compared with the other battery types in use today. For example, nickel-cadmium (Ni—Cd) has an energy density that can be 100-145 watt hour/liter. This illustrates the difference in battery types and, since the change to lithium-ion is not consistent with the weight savings aspect, new materials may be desirable. Also, for applications where a lighter battery is desired, but capacity and energy density is not an issue, a less expensive battery made from less costly flexible and lighter material would be substituted for the currently used battery materials.

### SUMMARY OF THE INVENTION

Therefore, a need has arisen for electrically conductive coatings comprising conductive materials formed from a dispersion, suspension, or mixture of conductive material with low solids concentration that will form a conductive surface, has good adhesion to a chosen substrate, is ductile, has the ability to transfer heat, and is chemically resistant to electrolytes and acids after it is applied to the substrate and cured. The present novel application can be used to inexpensively coat non woven and woven substrates and other materials using a process that can be scaled up to industrial production size and results in materials well-suited for applications where an electrically conductive surface that is ductile, has the ability to transfer heat, is chemically resistant to electrolytes and acids, and has a high bond strength is desired. The substrates can either be made from non conductive materials or fabrics designed so that the untreated material has a conductivity of one or more mega ohms per square. Battery current collectors, anodes, and cathodes are such applications. Other applications where this technology may be used include fuel cells, photovoltaic cells, solar panels, implantable and inductively charged batteries, and electrochemical cells. Since the materials of the invention can be applied to lightweight plastics or other non-conductive materials, the resulting conductive members are lighter in weight than materials currently used, cost less, and can be made into non-metal implantable batteries. By using the lightweight material of the invention as inner components, a non metal case can be used because it can adequately support the structural and vibration requirements of the battery.

In one aspect of the present invention, a conductive carbon nanotube layer is formed by coating the substrate with conductive carbon nanotube dispersion. The dispersions can be made from SWNT or MWNT, preferably sized to be less than 20 nm and greater than 0.5 nm in diameter. Additionally, conductive dispersions such as Acheson Electrodag PF 427 ATO ink can be alloyed with either SWNT or MWNT and nanotube bundles or ropes, preferably sized to be greater than 0.5 nm and less than 20 nm in diameter. This is done to achieve a coating that facilitates adhesion to the base material, has excellent conductivity, both thermally and electrically, and is sufficiently ductile. When Acheson Electrodag PF 427 ATO ink is alloyed with either SWNT or MWNT, preferably sized to be greater than 0.5 nm and less than 20 nm in diameter, the resulting coating is approximately 1100 ohms/sq for electrical conductivity and 650 Watts/meter kelvin for thermal conductivity after curing. The carbon nanotube bundles or ropes formed during the curing process provide the mechanism for this desirable conductivity.

The carbon nanotubes are mixed uniformly into the Acheson Electrodag PF 427 such that the percent by weight is 0.0001% to 10%. Preferably, the carbon nanotubes are added such that they make up 1% by weight of the mixture. Additionally, platinum nano particles can be added and mixed uniformly into the coating such that the percent by weight is 0.5% to 10%. Preferably, the nano size platinum particles are added such that they make up 0.01 to 10% by weight of the mixture. Also, nano particles or other metals such as silver, silver oxide, zinc oxide, copper, gold, lead, other metals and oxides as well as metal oxides can be used to produce conductive coatings, inks and dispersions of the invention. Any commercially available conductive or specialty conductive ink, paint, or coating can be used that is formed from conductive organics, inorganics, metals, oxides, metal oxides and/or carbon in the embodiments described.

Additionally the coating can be made using KYNAR FLEX 2801 from Arkema Inc. KYNAR FLEX 2801 is a polyvinylidene fluoride (PVDF), which is an addition polymer produced by the free radical polymerization of vinylidene fluoride (VF₂). Structurally, this free radical polymerization results in CH₂ and CF₂ groups alternating in the PVDF polymer. This type of structure is found in the KYNAR® homopolymers. KYNAR FLEX® copolymers differ from the pure homopolymer in that a comonomer, hexafluoropropylene (HFP), is added to modify the polymer structure.

In another aspect, the KYNAR FLEX 2801 (or any other PVDF) is mixed with MWNT or DWNT carbon nanotubes in acetone and sonicated to create a dispersion. Silver flakes may or may not be added to the dispersion. The dispersion is then sprayed onto a substrate, allowed to dry, and cured for a minimum of 20 minutes at 95 degrees C. The substrate may be woven or non woven polymer or organic material. In one embodiment, the substrate is Hollytex 3234.

In another aspect, the coatings can be used to inexpensively coat low melting point polymer non woven substrates or organic woven substrates using a process that can be scaled up to industrial production proportion. The substrates can either be made from non conductive materials or fabrics designed so that the untreated material has a conductivity of one or more mega ohms per square. They can also be blended with various metals to form catalyst or active material layers. When these catalyst or active material layers are applied as part of the top coating, the amount of material required to achieve similar results when compared to uniform dispersion, suspension, or mixture of conductive material catalyst or active material layers is reduced. These layers can contain platinum, carbon, silver, zinc, lead and PbO₂, silver oxide, zinc oxide, Au—Ni, Au—Fe, Au—Co and Au—Ir, bi-metallics alloys, lead, LiNiCoO₂, LiNiCoAlO₂, LiNiMnCoO₂, coke, graphite, tin, mesocarbon microbeads (MCMB), silicon, non-metal oxides and metal oxides, as well as mixtures of oxides such as metal oxides or non-metal oxides such as silicon oxide. The metal particle sizes range from 0.5 nm to 40 nm. Such materials can be used in batteries and fuel cells. The materials of the invention can be used as current collectors in batteries where their lightweight and high conductivity can replace the existing heavier lead, copper, and/or aluminum current collectors. When the oxides are mixed with various carbon nanotubes or lithium compounds, they can be used to replace the traditional lithium-ion materials. When used with lead acid batteries, the coating can be alloyed with nano size lead to increase the lead content of the replacement current collector or grid. The materials of the invention can be used to form integrated bipolar elements in batteries where their light weight and high conductivity can replace the existing heavier materials and wherein the ability to form the materials in separate layers makes the formation of a bipolar structure possible. When alloyed with a catalyst such as platinum, Au—Ni, Au—Fe, Au—Co and Au—Ir or carbon, they make excellent catalysts for use in Proton Electrolyte Membrane (PEM) Fuel Cells or Solid oxide fuel cells (SOFC). When these catalyst layers are applied as part of the top coat, the amount of catalyst required to achieve similar results when compared to uniform dispersion catalyst layers is reduced. The dispersion, suspension, or mixture of conductive material of the present invention, when used in a conductive coating, are especially well suited for use with electrochemical applications where high conductivity and bond strength improves the performance of the application. Applications where this technology may be used include batteries, fuel cells, photovoltaic cells, solar panels, antennae, and electrochemical cells.

In another aspect, the invention provides a method for making bipolar battery elements where the separator, active materials, and current collection material are all integrated into one element.

In another aspect, the invention provides a method for making multi-layer battery elements where the carrier, active materials, and current collection material are all integrated into one element.

In another aspect, the invention provides a method for making a single layer battery element for use as a current collector or grid, where the carrier and current collector material are integrated into one element.

In another aspect, the invention provides a multi-layered structure comprised of electrically conductive inks and coatings formed from a dispersion, and a woven or non woven substrate layer is disposed on at least a portion of the electrically conductive coatings. The substrates can either made from non conductive materials or fabrics designed so that the untreated material has a conductivity of one or more mega ohms per square.

In another aspect, the invention provides a multi-layered structure comprising electrically conductive coatings formed from a dispersion and a woven or non woven substrate layer disposed on at least a portion of electrically conductive inks and coatings in communication with a semi-conductive substrate.

In another aspect, the invention provides a multi-layered structure comprising electrically conductive coatings on woven or non woven substrates formed into cells or batteries in a plastic or non-conductive housing capable of being implanted and inductively charged.

Other objects, features and advantages of the present invention will become apparent from the following detailed description. It should be understood, however, that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

FIG. 1 is an example of the anode and cathode material on non woven separate substrates for a lithium secondary battery, of the present invention.

FIG. 2 is a schematic representation of a battery having a non-metal case.

### DETAILED DESCRIPTION OF THE INVENTION

The conductive coatings formed by using dispersions, suspensions, or mixtures of conductive materials made from carbon nanotubes overcome the problems of prior high solids concentration coatings found in conductive coatings manufactured from methods described in the prior art; the carbon nanotubes and coatings made from alloys of carbon nanotubes have improved adhesion, increased repeatability of the conductive properties both electrically and thermally, low coefficient of friction, better ductility, improved heat transfer capabilities, and are chemically resistant to electrolytes and acids when the dispersions of carbon nanotubes are applied and cured. The curing process allows the carbon nanotubes to form bonds between themselves and other conductive materials in the dispersion after it is applied to a substrate. In batteries and other electrochemical applications, these coatings form conductive elements that can replace existing metal current collectors, grids and foils to transfer electrons to the cell or battery terminals, provide a heat dissipation medium to the battery or cell wall where the heat is dissipated by transfer to the surrounding environment, and do not interfere chemically with the electrochemical reaction.

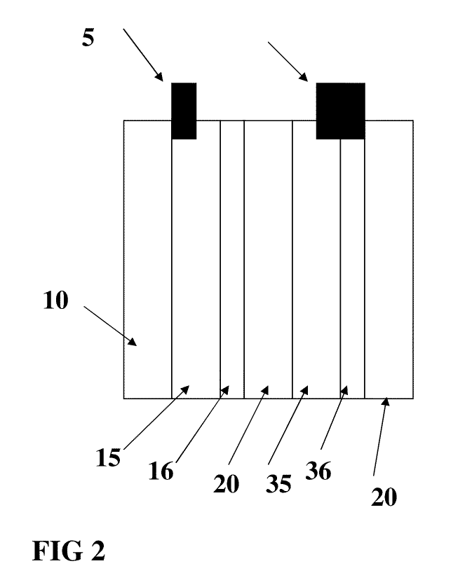

Furthermore, battery weight may be able to be further reduced by changing the basic battery components. Such a change in components may entail replacing traditional metals with new lightweight and flexible materials in the forms of coatings and/or films. To accomplish this, the coatings and films should be free from decomposition due to electrolytic solutions used in the batteries, they should be capable of transferring both heat and current, they should be resistant to decomposition from the effects of the heat generated by charging and discharging and they should not interfere chemically with the electrochemical reaction. Moreover, as the proliferation of implantable medical devices grows, an implantable battery could be configured to work in implantable devices, such as defibrillators, pace makers and hearing aids, and could be designed to be inductively charged, virtually eliminating secondary surgery for the purpose of replacing batteries. To facilitate the production and operation of an implantable device with an inductively charged battery, the battery would contain little or no metal to enable inductive charging. This battery would include a non-metal case, as is shown in FIG. 2. Changing the case means that lighter more flexible material is used as inner components so that the case can adequately support the structural and vibration requirements of the battery.

The disclosures of both U.S. patent application Ser. No. 11/505,156, filed on Aug. 15, 2006, entitled “Coatings comprising of carbon nanotubes” and U.S. Provisional Application No. 60/708,510, filed on Aug. 15, 2005, entitled “Creation of carbon nanotube suspension formulation” are incorporated herein by reference in their entireties.

The present invention is directed to methods for improving the adhesion, ductility, flexibility, and electrical and thermal conductivity of coatings made from dispersions, suspensions, or mixtures of conductive material of carbon nanotubes, conductive organic and inorganic materials, and metals. The methods are especially suited for use in electrochemical applications where ductility, high bond strength, ability to transfer heat and current, as well as, chemical resistance to electrolytes and acids provide advantages for reduced cost and more consistent results. The increase in ductility, flexibility, and improved adhesion with regard to electrochemical applications in which the present invention is employed are related. Coatings with strong adhesion and good ductility generally resist cracking when bent, and the adhesion prevents the material from delaminating from the substrate and cracking. The conductive surface and the ability to transfer heat are provided by the carbon nanotubes, conductive organic and inorganic materials, and metals networked together by the conductive carbon nanotubes. The coatings are made from dispersions of carbon nanotubes, conductive organic and inorganic materials, and metals and are chemically resistant to electrolytes and acids. This property is derived from the ability to alloy the dispersion with materials resistant to these chemicals, the single carbon atom formations of the carbon nanotubes which present a high surface area chemical resistant component of the coating, and the ability of the carbon nanotubes to form tight bonds between all the materials.

The present invention also relates to conductive coatings made from dispersions, suspensions, or mixtures of conductive material of carbon nanotubes with low solids concentration. The conductive coatings made from dispersions of carbon nanotubes are used to form a conductive material and can be alloyed with other conductive and non-conductive materials to achieve desired results. The conductive and non-conductive materials include carbon nanotubes, carbon nanotubes/antimony tin oxide, carbon nanotubes/platinum, carbon nanotubes and carbon, carbon nanotubes/silver or carbon nanotubes/silver-chloride, lead, amorphous carbon, silver, zinc, carbon nanotubes and platinum, Au—Ni, Au—Fe, Au—Co and Au—Ir, bi-metallics and their oxides, LiNiCoO₂, LiNiCoAlO₂, LiNiMnCoO₂, coke, graphite, silver oxide, zinc oxide tin, mesocarbon microbeads (MCMB), silicon, non-metal oxides and metal oxides, Pb and PbO₂, platinum, Au—Ni, Au—Fe, Au—Co and Au—Ir, carbon, silver-chloride, silver, nickel, cadmium, zinc, with diameters from 0.5 nm to 100 microns or various nano metals such as nano size lead or nano oxide layers. These alloyed materials are formed with larger particles and applied such that the traditional conductive particles spread further from each other than in traditional applications of these materials. Dispersions formed from carbon nanotubes are used to interconnect the larger particles, creating surfaces with improved conductivity, when compared to thick film materials applied in an average thickness less than 0.002 inches, and have more reproducible properties than materials of the prior art. This is because with regard to the interconnection properties of the carbon nanotubes, all the particles within the coating may or may not be in contact with each other. The carbon nanotubes in the dispersion create a flexible joint that allows the joint to move and stay in electrical and thermal contact when the coating is stressed by heat, mechanical or chemical processes, without interfering chemically with the electrochemical reaction.

The conductive coatings are made from dispersions, suspensions, or mixtures of conductive material of carbon nanotubes, conductive organic and inorganic materials, metals and other nano size particles that result in electrical conductivity, ductility, high bond strength, the ability to transfer heat, and are chemically resistant to electrolytes and acids. These features provide advantages for reduced cost and results that are more consistent as compared to previous coatings after they are applied to a substrate and cured. This permits formation of the cured conductive coatings with improved adhesion formed from nano size particles and providing excellent physical properties including conductivity, both thermally and electrically, ductility, high bond strength, ability to transfer heat and chemical resistance to electrolytes and acids, while providing advantages such as reduced cost, when compared to metal foils and grids. The coatings of the invention are formed from conductive carbon nanotube dispersions that include, as part of the formulation, carbon nanotubes, carbon nanotubes and platinum, amorphous carbon, carbon nanotubes/antimony tin oxide, carbon nanotubes/platinum, amorphous carbon, silver, silver oxide, zinc, zinc oxide, lead, lead oxide or carbon nanotubes/silver or carbon nanotubes/silver-chloride carbon nanotubes, nano size metals, oxides, metal oxides and platinum. These dispersions, as part of a conductive coating applied to a non-conductive surface and cured, allow for the production of repeatable, ductile, high bond strength coatings that are able to transfer heat, are chemically resistant to electrolytes and acids, and provide advantages for reduced cost. The carbon nanotube coating, on alloying other conductive materials and solvents, creates a boundary layer between the substrate and the other components of the coating such that the overall coating adheres better to the substrate, providing the carbon nanotubes with a pathway to increase the conduction of thermal and electrical energy between the other conductive materials in the coating. Dispersions of the invention are used to form conductive coatings with the required chemical and thermal stability that has good adhesion to the base substrate and provides an excellent support for electrochemical processes.

The coatings are more capable of transferring heat and electrical current than existing printed ink technologies designed as dispersions, suspensions, or mixtures of conductive material of finely divided graphite, silver, or silver chloride particles in a thermoplastic resin and containing 20% to 60% solids. The carbon nanotubes form strong conductive bonds that are flexible and bond the carbon nanotubes and other alloying materials together. The finely divided particles of traditional coatings and inks tend to be at least 10 microns to 100 microns in diameter, creating an inconsistent conductive path. The carbon nanotube conductive coatings formed from dispersions of the present invention have the same conductive capacity and solid contents of about 0.0001% to 10% with a carbon nanotube particle size less than 20 nm for the carbon nanotube portion of the dispersion. Compared to conventional inks and coatings, this is significantly smaller than 10 micron particle size, and the solids content is 6 to 20 times less. The creation of coatings with thermal and electrical conductivity, good adhesion and high chemical resistance is the result of the carbon nanotubes that form the interconnecting bonds between the larger conductive materials and the physical properties of carbon nanotubes that make the transmission of both heat and current possible. Carbon nanotubes are purported to be 100 times as strong as steel and capable of far greater electrical conductivity than other carbon-based materials and are exceptional heat-conducting materials. The high bond strength and the natural affinity of the carbon nanotubes to link/clump together to form ropes and their thermal and electrical properties are beneficial to the coatings of the present invention.

Coatings of the present invention can be made from dispersions, suspensions, or mixtures of conductive material of single-wall nanotubes (SWNT), doubled walled (DWNT), or multi-wall nanotubes (MWNT), preferably sized to be less than 20 nm and greater than 0.5 nm in diameter. Additionally, commercially available conductive dispersions such as Acheson Electrodag PF 427 Antimony Tin Oxide (ATO) ink or Acheson Electrodag PF-407C conductive carbon ink can be alloyed with either SWNT, DWNT, or MWNT, preferably sized to be less than 20 nm and greater than 0.5 nm in diameter, thereby increasing their conductivity both electrically and thermally, improving surface morphology, improving adhesion and ductility to the substrate, and improving chemical resistance. Any commercially conductive or specialty conductive ink or coating can be used that is formed from conductive organics, inorganics, metals, oxides, metal oxides, and carbon applied in a first layer. The commercially available conductive material, or a formulated material with similar properties, can then be applied in a thinner second layer. The carbon nanotube dispersion creates the conductive connections to achieve similar or greater conductivity with improved durability because the presence of larger particle solids that achieves the conductivity is reduced with the conductive material approaching a mono layer of larger particles bridged by the layer of significantly smaller carbon nanotubes. The carbon nanotube and solvent mixture also helps adhere the coating to the substrate, thereby improving resistance to mechanical and chemical damage. As an alternative to the two layers, the two coating materials can be mixed together and applied as one coating. The commercially available conductive material, or a formulated material with similar properties, and the carbon nanotube dispersion are mixed together so that they form a uniform dispersion. The resulting dispersion, suspension, or mixture of conductive material is mixed and applied to a substrate by spraying. The dispersion may also be applied by a method selected from the group consisting of spray painting, dip coating, spin coating, knife coating, kiss coating, gravure coating, screen printing, stenciling, flexo (flexographic) printing, and pad printing, and then heat cured for a specific amount of time which is optimally 20 minutes at 90 degrees C. as described in U.S. patent application Ser. No. 11/505,156, filed on Aug. 15, 2006, entitled “Coatings comprising of carbon nanotubes” and U.S. Provisional Application Ser. No. 60/708,510, filed on Aug. 15, 2005, entitled “Creation of carbon nanotube suspension formulation,” both disclosures being incorporated herein by reference in their entireties. One application of the invention involves the application of either Acheson Electrodag PF 427 ATO ink or Acheson Electrodag PF-407C conductive carbon ink by diluting the ink with a solvent and applying it to a substrate. This creates a coating with significantly less solids than the screen printable ink. Additional layers of carbon nanotube dispersion are then applied over the first layer to enhance conductivity. This second application improves the chemical resistance and conductivity of the coated substrate beyond that of the initial layer because the single carbon atom formations of the carbon nanotubes which presents a high surface area chemical resistant component of the coating and the ability of the carbon nanotubes to form tight bonds between all the materials.

Before being applied as a coating, the materials can also be blended with various metals to form catalyst or active material layers. When these catalyst or active material layers are applied as part of the top coating, the amount of catalyst or active material is reduced to achieve similar results when compared to uniform dispersion catalyst or active material layers. These layers can contain carbon, Au—Ni, Au—Fe, Au—Co and Au—Ir, bi-metallics and their oxides, LiNiCoO₂, LiNiCoAlO₂, LiNiMnCoO₂, coke, graphite, tin, mesocarbon microbeads (MCMB), silicon, non-metal oxides and metal oxides, Pb and PbO₂, platinum, carbon, silver-chloride, silver, silver oxide, zinc oxide, nickel, cadmium, zinc, the particles of which may have diameters from 0.5 nm to 100 microns or greater, or nano metals such as nano size lead or various nano oxide layers that can be used in batteries or fuel cells. The metal particles or oxides range in size from 0.5 nm to 40 nm. Such materials can be used in either primary or secondary batteries and fuel cells. The materials of the invention can be used as current collectors in batteries where their lightweight and high conductivity can replace the existing metal (e.g., copper, lead, aluminum) current collectors. When the oxides are mixed with various carbon nanotubes or lithium compounds, they can be used to replace the traditional lithium-ion materials. When used with lead acid batteries, the coating can be alloyed (or combined) with nano size lead to increase the lead content of the current collector/grid. When alloyed with a catalyst or active material such as platinum, silver oxide, zinc oxide, silver, zinc, lead and PbO₂, platinum, Au—Ni, Au—Fe, Au—Co and Au—Ir, carbon, LiNiCoO₂, LiNiCoAlO₂, LiNiMnCoO₂, coke, graphite, tin, mesocarbon microbeads (MCMB), silicon, non-metal oxides and/or metal oxides or nano oxide layers or nano metals such as nano size lead, the coatings can operate as catalysts in electrochemical applications, proton electrolyte membrane fuel cells (PEMFC), or in solid oxide fuel cells (SOFC). MCMB layer reactivity may be improved when alloyed with carbon nanotubes due to the increased carbon surface area provided by the carbon nanotubes. When these catalyst or active material layers are applied as part of the top coating, the amount of catalyst or active material used to achieve similar results is reduced when compared to uniform dispersion catalyst or active material coatings.

The coatings formed from the dispersions of the present invention, when compared to the commercially available Acheson Electrodag coatings, exhibit improved adhesion to the substrate. This is seen when a 1 mm stainless steel flat edge implement is used to scratch the surface using 10 grams of force and a lower coefficient of friction is observed. The Acheson Electrodag is applied per supplier specification. The modified dispersion of the invention is applied and cured for 20 minutes at 90 degrees C. The Acheson Electrodag coating is removed leaving the uncoated substrate, whereas the coating of the invention is still attached and remains adhered to the substrate after the 1 mm stainless steel flat edge is used to scratch the surface using 10 grams of force.

Alternatively, a non-conductive binder can be used to form a dispersion, suspension, or mixture of conductive material used in the conductive coating or ink. The small size of the carbon nanotubes enhances adhesion of the coating to the base substrate for these conductive coatings because of their ability to bind to other materials. The carbon nanotubes are blended into the non-conductive binder such that the percent by weight is 0.001% to 10%. Preferably, the carbon nanotubes are added such that they make up 1% by weight of the mixture. Additionally, metal nano particles (e.g., platinum, silver, gold), oxide nano particles, such as silicon dioxide or metal oxides can be added and mixed uniformly to the coating such that the percent by weight is from 0.5% to 10%. Preferably, the nano size platinum particles are added such that they make up 2% by weight of the mixture. Then a solvent appropriate to the specific substrate, such as chloroform, acetone or other suitable solvent for dissolving the polymer substrate, is added to the mixture to reduce the viscosity and form a liquid. The resulting dispersion is sonicated, or mixed, and applied to the substrate. The carbon nanotubes and/or nano size metals knit together to form a conductive surface when the dispersion is applied to a substrate and cured. This provides porous mechanical protection and permits the passage of electrons. The binder, which is preferably a polymer, is not conductive; the carbon nanotubes and metal nano particles provide the conductive pathway. The non-conductive polymer binder is used to coat the conductive particles that form the coating and protect it from wear. The polymeric material for the binder is selected from the group consisting of thermoplastics, thermosetting polymers, elastomers, conducting polymers and combinations thereof. These polymeric materials can be selected from the group consisting of polyethylene, polypropylene, polyvinyl chloride, styrenic compounds, polyurethane, polyimide, polycarbonate, polyethylene terephthalate, cellulose, gelatin, chitin, polypeptides, polysaccharides, PVDF such as KYNAR, KYNAR FLEX, Poly(methylmethacrylate), polynucleotides and mixtures thereof, or ceramic hybrid polymers, Ethylene Glycol Monobutyl Ether Acetate, phosphine oxides, and chalcogenides. The present invention is not limited in this regard, as other binders may be used. In any embodiment, the binders may be curable using infrared radiation, heat convention, ultraviolet radiation, electron beam, oxidation, air curing, cross-linking, and/or catalyzation.

The current collector materials of currently available commercial batteries are lead, silver, stainless steel, zinc, copper, carbon, graphite or aluminum. These metals provide the following advantages: they are resistant to chemical degradation from electrolyte materials, they do not interfere chemically with the electrochemical reaction of the battery, and they are capable of conducting electrons to the battery terminals. Materials of the present invention also provide the added benefits of lighter weight, lower cost, ductility, elimination of metal components, and the ability to form lightweight bipolar structures that are not envisioned in the prior art. These benefits can be used to achieve the following novel batteries:
1) Lighter weight batteries are achieved by eliminating metal current collector components. This will allow the manufacture of lightweight batteries for military applications, aerospace, electric vehicles and consumer electronics.
2) Flexible, or ductile, battery components are achieved by eliminating the metal current collector components. Metal current collector materials make battery components brittle and subject to cracking. This will allow the manufacture of flexible batteries for credit cards, aerospace, and consumer electronics.
3) Implantable batteries formed from non-metal components can be fabricated producing inductively charged batteries or cells for medical applications that would also have non-metal cases. Utilizing a non-metal case means that lighter material can be used as the inner components of the batteries so that the case can adequately support the structural and vibration aspects of the batteries. By using the lightweight material of the invention as inner components a non metal case can be used because it can adequately support the structural and vibration requirements of the battery.

Formation of lightweight bipolar structures (e.g., a current collector) of the present invention is achieved by printing active layers of materials onto a porous substrate of non woven and/or woven fabric, thereby forming a coating on the fabric. The fabric is either made from non conductive materials or designed so that the fabric prior to being printed on has a conductivity of one or more mega ohms per square. When the fabric is either non conductive or designed to have a conductivity of one or more mega ohms per square, the weight of the current collector and active material structure is minimized. An alternate method creates a bipolar device with two active layers printed onto a current collector support substrate to form the coating. In any embodiment of the lightweight bipolar structures of the present invention, the superior properties of carbon nanotubes form coatings that are chemically resistant, do not interfere chemically with the electrochemical reaction, are electrically and thermally conductive, are flexible, and provide good adhesion to the substrate to host an electrochemical reaction.

Appropriate materials from which the substrate of non woven or woven fabric include, but are not limited to, sheets of material composed of nylons, polyesters, polyethylene, polypropylene, fluorocarbon polymers, and combinations of the foregoing, any of which may be woven and/or non woven fibers. Other appropriate materials include stainless steel meshes.

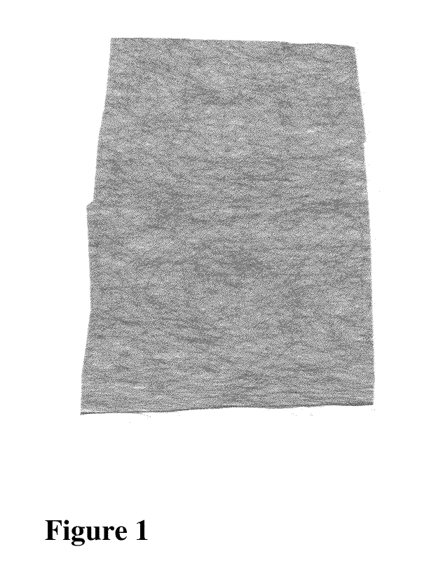

Also appropriate for this purpose would be papers and glass fiber papers. The porosity or mesh opening of any of the foregoing materials can range from about 5 to about 5000 microns. In a preferred embodiment, the material of the first layer is a substrate of non woven polyester fiber such as Hollytex 3234 or Hollytex 3257, both of which are available from Ahlstrom Filtration Inc., Mount Holly Springs, Pa. These materials form a porous substrate which allows the coating to form a three dimensional structure throughout the substrate The present invention is not limited in this regard, however, as a bibulous material such as cotton or linen can be used. Referring to FIG. 1, a non woven substrate on which the coating is disposed to form anode and cathode material for a lithium secondary battery is shown.

The carbon nanotubes, and the mixture thereof applied to the fiber, preferentially adhere to the outer diameter of the fiber forming a conductive mat around the fiber, which is fixed in place after curing. The process of curing facilitates the formation of the conductive material because the curing time allows the carbon nanotubes to form suitable bonds to the fibers. As used herein, the term “dispersion” means any suspension or mixture of conductive material and carbon nanotubes.

The coatings of the present invention formed from the dispersion of the carbon nanotubes, when compared to commercially available coatings, exhibit electrical and thermal properties. Using the polyester non woven polyester substrate (such as Hollytex 3234) and the carbon nanotube dispersions described herein, the carbon nanotubes are incorporated into the conductive coatings. Such coatings exhibit an improved electrical resistivity as compared to other coatings. The concentration of the carbon nanotubes and the thickness of the carbon nanotube filled conductive coatings are improved over other coatings. The resistivity can also be adjusted from 100 ohms squared to 100,000 ohms squared at any thickness greater than 1 micron. The thermal conductivity, furthermore, which is measured in watts per meter per Kelvin, provides a suitable mechanism to transport heat generated by the battery (or cell) during charging and discharging.

The coatings of the present invention used for testing as described in the Examples below were made for assessing comparative properties. In particular, testing was performed on conductive coating samples incorporating carbon nanotube dispersions applied in a multi-step process and as a single dispersion. In this matrix of samples, all preparation conditions, procedures, and materials were identical for each of the conductive inks and coatings made. Each sample had an approximately uniform final conductive coating thickness of about 0.0001 inches applied to the polyester substrate. The loading concentration of carbon nanotubes was determined from preliminary test conductive coatings created with carbon nanotube coatings with weight percentages between 0.03% and 3%. The coating thickness was selected to be 1 mil or less. The resulting sets of specimens were used in a test matrix comparing electrical resistivity and thermal conductivity. The preparation and results of testing the samples in this matrix are presented as listed above.

### Example

### Preparation and Test Results for Samples

The first sample (sample 1) was made with a conductive polymer, Acheson Electrodag—PF 427, a polymer ink with ATO that has a low solids content and high resistance level when applied in a thin layer. A mixture of carbon nanotubes was formed by adding 0.056 grams of SWNT selected from a group of carbon nanotubes where the average diameter is less than 20 nanometers, and more preferably less than 10 nm, to 40 ml acetone. The mixture was sonicated using a SANYO MSE SONIPREP 150 tuned to 23 kHz at high power for 30 minutes while ensuring that the acetone level did not drop below the 40 ml mark. In instances in which the acetone dropped below 40 ml, more acetone was added. The solvent temperature was monitored. The mixture was removed from heat and sonication and allowed to cool. The resulting mixture was a dispersion of SWNT.

In a next step, 0.87 grams of Acheson Electrodag—PF Acheson PF-407C, which is a dispersion of conductive carbon and polymer, was modified by adding 1500 micro liters of acetone. The mixture was sonicated using a SANYO MSE SONIPREP 150 tuned to 23 kHz at high power for 10 minutes so that it could be spray coated onto Hollytex 3234 substrate panels. Prior to application, the panels were cleaned with methanol and dried. After spray coating the PF-407C layer, the carbon nanotube dispersion from the first step was spray coated over the diluted Acheson Electrodag—PF 407C and cured for 1 minute at 95 degrees C. The application of carbon nanotubes and the curing step was repeated six additional times per side, forming a total of seven applications per side of carbon nanotube dispersion. Finally, the composite matrix was cured by drying for 20 minutes at 95 degrees C.; the permissible variation was 10 to 25 minutes and 75 to 100 degrees C.

The benefit of this process is that when using a diluted, more traditional conductive coating, the coating can be applied in a much thinner layer. The carbon nanotube dispersion applied to the top surface forms interconnecting structure between the larger conductive particles, transferring electrical and thermal energy more efficiently. The process allows the layers to be applied more thinly and the carbon nanotubes form the conductive bonds. The carbon nanotube layers can be applied such that they create a layer with a thickness of less than 25 microns and the traditional conductive coating can be applied in a thickness between 25 microns and 0.01 inches. This is thinner than traditional coating application and results in conductivity of the coating formed with the dispersion of the invention greater than the traditional coating process.

The second sample (sample 2) was a dispersion of carbon nanotubes formed by adding 20 mg of MWNT or double-wall carbon nanotubes (DWNT) to 40 ml of acetone. The solution was sonicated using a SANYO MSE SONIPREP 150 tuned to 23 kHz at one-quarter power for 5-10 minutes. The solution was heated to 80 degrees C. and sonicated on high power for 30 minutes while ensuring that the acetone level did not drop below the 40 ml mark. In instances in which the acetone dropped below 40 ml, more acetone was added. The solvent temperature was monitored, and the solution was removed from heat and sonication and allowed to cool. The resulting mixture was a dispersion of MWNT.

The dispersion was added to Acheson Electrodag—PF 725A, a polymer ink with silver. A vial was charged with 0.89 gm of Acheson Electrodag—PF 725A and 1500 micro liters of the dispersion was added to the vial. Then 1000 microliters of acetone was added to the vial and the mixture was sonicated, or mixed, for 20 minutes to form a final mixture. The mixture was sprayed with a stencil onto polyester non woven substrate panels of Hollytex 3234 and allowed to dry. The conductive pigment and carbon nanotube mixture coating was cured a minimum of 20 minutes at 95 degrees C.

The third sample (sample 3) was made using KYNAR FLEX 2801 from Arkema Inc. A beaker was charged with 0.600 grams of the KYNAR FLEX 2801 and 20 mg of MWNT or double-wall carbon nanotubes (DWNT) carbon nanotubes. Then, 40 ml of acetone was added to the beaker. The solution was sonicated using a SANYO MSE SONIPREP 150 tuned to 23 kHz at one-quarter power for 30 minutes while ensuring that the acetone level did not drop below the 40 ml mark. In instances in which the acetone level dropped below 40 ml, more acetone was added. The solution was removed from sonication, and a dispersion had been created. Then the mixture was sprayed with a stencil onto woven linen panel and allowed to dry. The conductive carbon nanotube coating was cured a minimum of 20 minutes at 95 degrees C. When curing was done using different temperature values and for varying times, the conductivity results were not as desirable as they were in samples 1 and 2.

The fourth sample (sample 4) was made using KYNAR FLEX 2801 from Arkema Inc. A beaker was charged with 0.600 grams of the KYNAR FLEX 2801 and 20 mg of MWNT or double-wall carbon nanotubes (DWNT) carbon nanotubes. Then, 40 ml of acetone was added. The solution was sonicated using a SANYO MSE SONIPREP 150 tuned to 23 kHz at one-quarter power for 30 minutes while ensuring that the acetone level did not drop below the 40 ml mark. In instances in which the acetone level dropped, more acetone was added. The resulting dispersion was removed from sonication. Then 1 gram of SilFlake 135 silver flake from Technic was added to the dispersion. Sonication was resumed using the SANYO MSE SONIPREP 150 tuned to 23 kHz at one-quarter power for 30 minutes ensuring that the acetone level did not drop below the 40 ml mark. In a next step, 0.3 grams of the KYNAR FLEX 2801 and 10 ml of acetone was added and sonication resumed at 23 kHz at one-quarter power for 30 minutes. The mixture was then sprayed through a stencil onto non woven and woven organic panels (linen) and allowed to dry. The conductive carbon nanotube coating was cured a minimum of 20 minutes at 95 degrees C.

Tables 1-4 provide the results of coating Hollytex 3234 and linen to be conductive and the results when cured at different temperatures and curing times. As can be seen the curing time and curing temperature have an effect on the conductivity of the dispersion when printed Hollytex 3234.

TABLE 1
Dispersion system modified with conductive
carbon nanotubes sample 1.

| Curing time and | | Thermal Conductivity |
|---|---|---|
| temperature | Ohms/Sq. | (Watts/meter/Kelvin) |
| Cured for 20 minutes | 50 | 4,700 |
| at 95 degrees C. | | |
| Cured for 10 minutes | 450 | 3,100 |
| at 95 degrees C. | | |
| Cured for 20 minutes | 800 | 50 |
| at 70 degrees C. | | |
| Cured for 10 minutes | Not conductive | Not conductive |
| at 45 degrees C. | | |

TABLE 2
Dispersion system modified with conductive
carbon nanotubes sample 2.

| Curing time and | | Thermal Conductivity |
|---|---|---|
| temperature | Ohms/Sq. | (Watts/meter/Kelvin) |
| Cured for 20 minutes | 60 | 3,920 |
| at 95 degrees C. | | |
| Cured for 10 minutes | 80 | 2,600 |
| at 95 degrees C. | | |
| Cured for 20 minutes | 1200 | 50 |
| at 70 degrees C. | | |
| Cured for 10 minutes | Not conductive | Not conductive |
| at 45 degrees C. | | |

TABLE 3
Dispersion system modified with conductive
carbon nanotubes sample 3.

| Curing time and | | Thermal Conductivity |
|---|---|---|
| temperature | Ohms/Sq. | (Watts/meter/Kelvin) |
| Cured for 20 minutes | 5 | 3,700 |
| at 95 degrees C. | | |
| Cured for 10 minutes | 50 | 2,200 |
| at 95 degrees C. | | |
| Cured for 20 minutes | 470 | 1250 |
| at 70 degrees C. | | |
| Cured for 10 minutes | not conductive | not conductive |
| at 45 degrees C. | | |

TABLE 4
Dispersion system modified with conductive
carbon nanotubes embodiment 4.

| Curing time and | | Thermal Conductivity |
|---|---|---|
| temperature | Ohms/Sq. | (Watts/meter/Kelvin) |
| Cured for 20 minutes | 1 | 4,600 |
| at 95 degrees C. | | |
| Cured for 10 minutes | 20 | 3,200 |
| at 95 degrees C. | | |
| Cured for 20 minutes | 300 | 950 |
| at 70 degrees C. | | |
| Cured for 10 minutes | not conductive | not conductive |
| at 45 degrees C. | | |

### Example 2

### Battery Manufacture

Referring now to FIG. 2, an anode 15 and an anode current collector 16 was prepared using a dispersion system modified with conductive carbon nanotubes as in sample 1. The material was applied to the substrate (a Hollytex 3234 panel) which was 4 inches by 2 inches to form current collector 16 and dried by warm air at approximately 90 degrees C. for 20 minutes. This panel is shown in FIG. 1. The panel was then coated with a dispersion of 80% by weight of graphite flake and 20% by weight of KYNAR FLEX 2801 polymer binder suspended in N-Methyl-2-Pyrrolidone (NMP) on both sides of the Hollytex panel. The panel was then dried to form anode 15. A copper tab 5 was then welded to the Hollytex panel by using ultrasonic energy as described in co pending application Ser. No. 11/897,077 entitled “Bondable conductive ink,” the disclosure of which is incorporated by reference herein. A linen panel 4 inches by 2 inches was then used to form a cathode current collector 36 for a cathode 35 which is prepared as described using a dispersion system modified with conductive carbon nanotubes as in sample 1. The material was applied to a linen panel and dried by warm air at approximately 90 degrees C. for 20 minutes to form the cathode current collector 36. An aluminum tab 25 was welded to the Hollytex panel by using ultrasonic energy as described in co pending application Ser. No. 11/897,077. The panel was then coated with a dispersion of 80% by weight of LiFePO₄ powder and 20% by weight of KYNAR FLEX 2801 polymer binder suspended in N-Methyl-Pyrrolidone NMP) on both sides of the linen panel to form cathode 35. This panel was then dried by warm air approximately 90 degrees C. for 20 minutes.

A case 10 was formed from a 0.010-inch thick polyethylene terephthalate (e.g., MYLAR) film and ultrasonically bonded to form a liquid tight seal on three sides.

The anode 15 and the anode current collector 16 were inserted into the housing 10, and a piece of 0.002 inch thick separator 20 of TONEN made by Exxon was inserted on the side of the anode 15. The cathode 35 was then inserted in the case 10 facing the separator 20. Then, 30 ml of lithium cell electrolyte formed from LiPF₆ suspended in a nonaqueous solvent such as an organic carbonate was placed in the case 10. The top of the case 10 was then sealed around tabs 5 and 25 such that the tabs extended out of the sealed case, thereby forming the battery cell as shown in FIG. 2.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A current collector for use in a battery capable of high energy discharge, said current collector comprising:
a non-conductive porous substrate; and
a dispersion coated on said non-conductive substrate, said dispersion comprising carbon nanotubes.

2. The current collector of claim 1, further comprising secondary conductive particles alloyed with said carbon nanotubes.

3. The current collector of claim 1, wherein said carbon nanotubes are selected from carbon nanotubes with diameters from 0.5 nm to 40 nm.

4. The current collector of claim 1, where the substrate is non conductive, non woven, and formed from a polymer.

5. The current collector of claim 2, wherein the secondary particles are selected from carbon, Au—Ni, Au—Fe, Au—Co and Au—Ir, bi-metallics and their oxides, LiNiCoO₂, LiNiCoAlO₂, LiNiMnCoO₂, coke, graphite, tin, mesocarbon microbeads (MCMB), silicon, non-metal oxides and metal oxides, Pb and PbO₂, platinum, silver, zinc, silver oxide, zinc oxide, wherein the secondary particles have diameters from 0.5 nm to 100 microns, or nano metals

6. The current collector of claim 1, wherein the dispersion comprises secondary particles are selected from carbon, Au—Ni, Au—Fe, Au—Co and Au—Ir, bi-metallics and their oxides, LiNiCoO₂, LiNiCoAlO₂, LiNiMnCoO₂, coke, graphite, tin, mesocarbon microbeads (MCMB), silicon, non-metal oxides and metal oxides, Pb and PbO₂, silver, zinc, silver oxide, zinc oxide, platinum, wherein the secondary particles have diameters from 0.5 nm to 100 microns, or nano metals

7. A battery made from the current collector of claim 1, the battery having a non-metal case.

8. A battery made from the current collector of claim 5, the battery having a non-metal case.

9. A current collector for use in a battery capable of high energy discharge, said current collector comprising:
a conductive porous polymer film formed from a dispersion comprising carbon nanotubes.

10. The current collector of claim 9, further comprising secondary conductive particles alloyed with said carbon nanotubes.

11. The current collector of claim 10, wherein said carbon nanotubes are selected from carbon nanotubes with diameters from 0.5 nm to 40 nm.

12. A battery, comprising:
at least one cell, the cell comprising an electrolyte;
a cathode in communication with the electrolyte;
a cathode current connector in communication with the cathode;
an anode in communication with the electrolyte;
an anode current collector in communication with the cathode;
at least one of the cathode current collector and the anode current collector comprising a non-conductive porous substrate and a dispersion coated on the non-conductive substrate, the dispersion comprising carbon nanotubes; and
a non-metal case housing the at least one cell.
